(19) United States
(12) Patent Application Publication
(10) Pub. No.: US 2016/0255700 A1
(43) Pub. Date: Sep. 1, 2016

(54) APPARATUS AND METHOD FOR DISRUPTING NIGHT VISION DEVICES

(71) Applicant: APOLLO DESIGN TECHNOLOGY, INC., Fort Wayne, IN (US)

(72) Inventors: Joel A. Nichols, Fort Wayne, IN (US); Alex TOLLINGTON, Fort Wayne, IN (US)

(73) Assignee: APOLLO DESIGN TECHNOLOGY, INC., Fort Wayne, IN (US)

(21) Appl. No.: 14/267,702

(22) Filed: May 1, 2014

(51) Int. Cl. H05B 37/02; H05B 33/08

(52) U.S. Cl. CPC H05B 37/029; H05B 37/0227; H05B 33/0854; H05B 37/0272

(57) ABSTRACT

Apparatus, systems and methods for disrupting night vision ability in an area surrounding the apparatus, where a first trigger is configured for generating a first activation signal for the apparatus. A sensor may be configured to detect a physical characteristic in or around the apparatus. A second trigger may be operatively coupled to the sensor to provide a second activation signal based on the detected physical characteristic in the sensor. A control circuit, which may include a strobing circuit, may be operatively coupled to the first and second trigger. A plurality of light emitting diodes may be arranged in a predetermined pattern, wherein the control circuit is configured to cause illumination of each of the plurality of light emitting diodes in a predetermined pattern to disrupt night vision in the area.

### TECHNICAL FIELD

The present disclosure relates to devices and methods for disrupting image intensification devices. More specifically, the disclosure relates to devices and methods for disrupting “night vision” devices such as scopes, goggles, binoculars, etc.

### BACKGROUND

Systems and devices for providing vision under low-light environments are known in the art and use of a variety of techniques for producing images that may be perceived by the naked eye. One such technique utilizes image intensifiers that are typically used in low-light imaging, such as night vision goggles, night-vision scopes, and the like. Image intensifiers typically operate by amplifying available light to achieve better vision, where an objective lens focuses available light (photons) on a photocathode of an image intensifier. The light energy causes electrons to be released from the cathode which are accelerated by an electric field to increase their speed (energy level). These electrons enter holes in a microchannel plate and bounce off the internal specially-coated walls which generate more electrons as the electrons bounce through. This creates a denser “cloud” of electrons representing an intensified version of the original image. Prior to imaging, electrons are configured to strike a phosphor screen, where the energy of the electrons makes the phosphor glow. The visual light shows the desired view to the user or to an attached photographic camera or video device. A green phosphor is used in these applications because the human eye can differentiate more shades of green than any other color, allowing for greater differentiation of objects in the picture.

Another technique for night vision involves the use of active illumination, which combines imaging intensification technology with an active source of illumination in the near infrared (NIR) or shortwave infrared (SWIR) band. Examples of such technologies include low light cameras. Active infrared night-vision combines infrared illumination using spectral ranges of 700-1,000 nm (just below the visible spectrum of the human eye) with CCD cameras sensitive to this light. The resulting scene, which would normally appear dark to a human eye, appears as a monochrome image on a normal display device. Because active infrared night-vision systems can incorporate illuminators that produce high levels of infrared light, the resulting images are typically higher resolution than other night-vision technologies. Laser range gated imaging is another form of active night vision which utilizes a high powered pulsed light source for illumination and imaging. Range gating is a technique which controls the laser pulses in conjunction with the shutter speed of a camera's detectors. Gated imaging technology can be divided into single shot, where the detector captures the image from a single light pulse, and multi-shot, where the detector integrates the light pulses from multiple shots to form an image. One of the key advantages of this technique is the ability to perform target recognition rather than mere detection, as is the case with thermal imaging.

While night vision has provided users of the technology with the ability to see individuals under low light conditions, there has been insufficient development in the area of defense against night vision. Specifically, there is a need in the art to be able to disrupt night vision capabilities across one or more spectrums efficiently and practically.

### SUMMARY

In view of the foregoing and other exemplary problems, drawbacks, and disadvantages of the conventional methods and structures, an exemplary feature of the present disclosure is to provide apparatuses and methods for disrupting night vision devices.

In one illustrative and exemplary embodiment, an apparatus is disclosed for disrupting night vision ability in an area surrounding the apparatus. The apparatus may utilize a trigger for generating a first activation signal for the apparatus, and a sensor configured to detect a physical characteristic in or around the apparatus. A second trigger may be operatively coupled to the sensor, wherein the second trigger provides a second activation signal based on the detected physical characteristic in the sensor. A control circuit may be operatively coupled to the first and second trigger, the control circuit comprising a strobing circuit. The apparatus further comprises a plurality of light emitting diodes arranged in a predetermined pattern, wherein the control circuit is configured to cause illumination of each of the plurality of light emitting diodes in a predetermined pattern to disrupt night vision in the area.

In another illustrative and exemplary embodiment, a method is disclosed for disrupting night vision ability in an area surrounding an apparatus, wherein the method comprised the steps of detecting, via a sensor in the apparatus, a physical characteristic in or around the apparatus and providing an activation signal in the apparatus based on the detected physical characteristic. The method further comprises activating a control circuit in the apparatus from the activation signal to cause illumination of each of a plurality of light emitting diodes in a predetermined pattern to disrupt night vision in the area.

In another illustrative and exemplary embodiment, an apparatus is disclosed for disrupting night vision ability in an area surrounding the apparatus. The apparatus may comprise a trigger, configured to provide an activation signal based on a stimulus, and a control circuit, operatively coupled to the trigger, the control circuit comprising a strobing circuit. A plurality of light emitting diodes comprising a plurality of diode types arranged in a predetermined pattern in the apparatus, wherein the control circuit is configured to independently cause illumination of each diode type of the plurality of light emitting diodes in a predetermined pattern to disrupt night vision in the area.

Further scope of applicability of the present disclosure will become apparent from the detailed description given hereinafter. However, it should be understood that the detailed description and specific examples, while indicating preferred embodiments, are given by way of illustration only, since various changes and modifications within the spirit and scope of the invention will become apparent to those skilled in the art from this detailed description.

### BRIEF DESCRIPTION OF THE FIGURES

The present disclosure will become more fully understood from the detailed description given herein below and the accompanying drawings which are given by way of illustration only, and thus, do not limit the present disclosure, and wherein:

FIG. 1 illustrates a block diagram for a night vision disrupting apparatus under one embodiment comprising a trigger, a secondary trigger and/or sensor, a strobing circuit and a control circuit operatively coupled to a light emitting diode (LED) array;

FIG. 1A illustrates a portion of a strobing circuit under an exemplary embodiment utilizing timed pulses for alternating and/or synchronizing LED pulses;

FIG. 2 illustrates a side view of a night vision disrupting apparatus under one exemplary embodiment comprising a casing suitable for grasping and throwing; and

FIG. 3 illustrates a front view of a night vision disrupting apparatus under another exemplary embodiment comprising a LED panel mounted on a stand and support.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

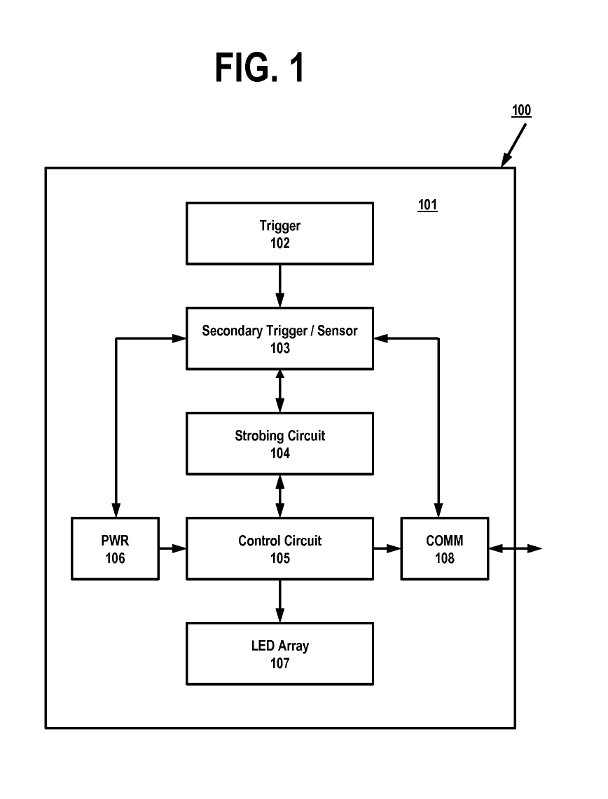

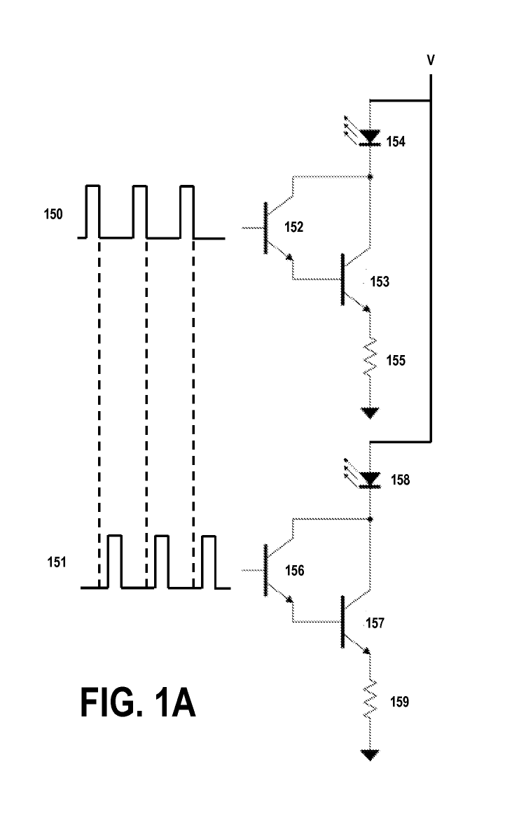

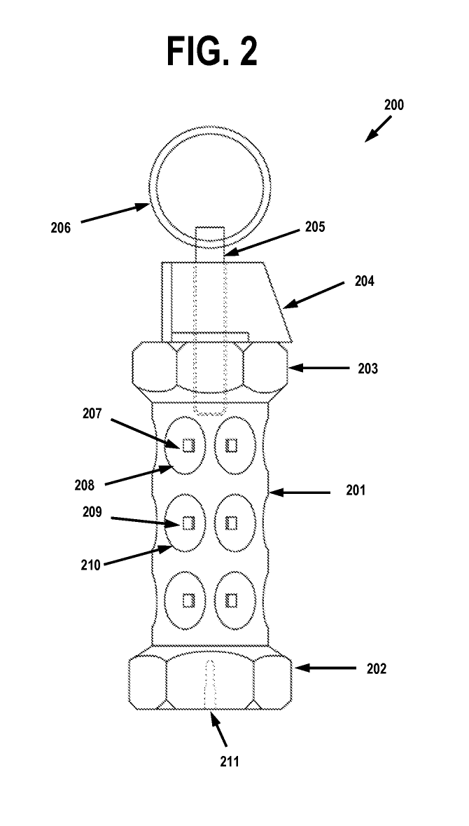

Turning to FIG. 1, an exemplary embodiment is provided for a night-vision disrupting device 100 that is preferably contained inside housing 101. Device 100 comprises a trigger 102, which may be a mechanical, electrical, or electromechanical switch, which activates operation using a stimulus within the device. In one example provided in FIG. 2 below, a trigger may comprise a pin 206 which may be pulled/latched by a user, similar to a hand grenade, to active the device via power supply 106. In another example, trigger 102 may be a button that electrically activates power 106. Once trigger 102 activates power in device 100, a secondary trigger 103 may be utilized, which may comprise a second switch, similar to trigger 102. The purpose of the secondary trigger 103 in this example would be to operate as a time delay, preferably under the control of control circuit 105, for activating LED array 107. Thus, device 100 could be activated via trigger 102 and physically placed in an area of defense, where LED array 107 would not be activated until secondary trigger 103 provides stimulus and is activated after a predetermined time delay.

In another embodiment, secondary trigger 103 may be part of a sensor, such as an accelerometer. Depending on the application needed, a variety of accelerometer types may be used. For example, a piezoelectric accelerometer (PEA) may be suitable for activating secondary trigger 103 based on shock and vibration. PEAs offer a wide measurement frequency range (a few Hz to 30 kHz) and may be configured in a wide range of sensitivities, weights, sizes and shapes. Piezoresistive accelerometers (PRA) generally have low sensitivity making them desirable for shock measurements and activation of secondary trigger 103. PRAs generally have a wide bandwidth and the frequency response may be calibrated down to zero Hz (also known as “DC responding”) or steady state, so they can measure long duration transients. Variable capacitance accelerometers (VCA) are similar to PRAs in that they are DC responding. VCAs have high sensitivities, and a narrow bandwidth, making them desirable for measuring low frequency vibration, motion and steady state acceleration for activating trigger 103. The accelerometer may also be packaged under a micro electro-mechanical system (MEMS) configuration for smaller size.

In one example, the accelerometer may be configured such that, after trigger 102 is activated, device 100 may be physically thrown. As the accelerometer will be able to measure the impact of device 100 on the ground, the sensed impact will activate secondary trigger 103 to activate LED array 107. In another example, the accelerometer may be tuned to detect vibrations such as those caused by vehicles or heavy machinery. After sensing a predetermined vibration, the accelerometer activates secondary trigger 103 to activate LED array 107.

It should be understood by those skilled in the art that other sensors may be used to effect activation of secondary trigger 103. For example, the sensor may be a MEMS microphone that senses sound in a particular area, where sounds exceeding given thresholds activate secondary trigger 103. Multiple microphones may also be used, where the multiple microphone outputs may be processed by control circuit 105 to determine a direction of sound, and, in response, alter the operation of LED array 107. In another example, the sensor may be a motion sensor. In another example, sensor 103 may be an apparatus for detecting the presence, direction, distance, and speed of aircraft, ships, and other objects, by sending out pulses of high-frequency electromagnetic waves that are reflected off the object back to the source, such as RADAR, or alternately LIDAR, LORAN or Sonar.

In another exemplary embodiment, secondary trigger 103 may be activated remotely via communications 108, which may be wireless RF communications, such as cellular, Wi-Fi, Bluetooth, or near-field communication (NFC), or other suitable communication medium. Using a remote triggering device, an activation signal may be transmitted from the remote device to disrupting device 100 using communications 108, which transmits the activation signal to secondary trigger 103 to activate device 100. In yet another exemplary embodiment, measurements from sensors in 103 may be wirelessly transmitted to a remote device (e.g., computer, cell phone) via communications 108. Upon receiving the measurements, a user may actively transmit an activation signal back to device 100 for activation. Alternately, received sensor measurements may be automatically processed in the remote device, where, if the sensor measurements meet or exceed a given threshold, the remote device automatically transmits the activation signal back to device 100. Such configurations may be advantageous in that sensor measurement processing may be offloaded from control circuit 105 to the remote device, which in turn reduced the processing and power requirements for device 100.

Continuing with the example of FIG. 1, disruption device 100 may be configured with a strobing circuit 104, which may be configured to control illumination and illumination sequence(s) of LED array 107, preferably with the assistance of control circuit 105. In one embodiment, control circuit 105 is a microprocessor equipped with a memory that is either integrated into the processor, or separately configured therefrom. The memory of control circuit 105 is preferably equipped with the necessary software or machine code to process activation procedures, LED activation and sensor measurement processing described herein. In one embodiment, strobing circuit 104 and control circuit 105 may be integrated together in one configuration. Depending on the specific application for disruption device 100, strobing circuit 104 (and control circuit 105) may control the illumination and/or sequence of illumination for the plurality of LED lights in LED array 107. In one embodiment, strobing circuit 104 turns all of the LEDs on and off according to the signal provided by secondary trigger 103. In another embodiment, strobing circuit 104 turns all the LEDs on and off independently of the secondary trigger 103 according to a predetermined sequence. In yet another embodiment, strobing circuit 104 turns individual or groups of LEDs on and off according to a predetermined sequence. In one embodiment, strobing circuit 104, control circuit 105 and LED array 107 may be packaged as a single unit.

Turning to FIG. 1A, an exemplary strobing circuit is provided. In the simplified example, two clock pulses 150, 151 are provided, where one pulse (150) is configured to have a different timing sequence from another (151) to alternate illumination control of LEDs 154, 158. It should be understood by those skilled in the art that, while LEDs 154, 158 are illustrated as single LEDs in the simplified example, the principles described herein are equally applicable to pluralities or banks of LEDs. Thus, as an example, LED control from clock pulse 150 may be applied to a first bank of LEDs (e.g., 20 LEDs in a 40 LED bank), while the control from clock pulse 151 may be applied to a second bank of LEDs (e.g., other 20 LEDs of the 40 LED bank). Similarly, any number of respective clock pulses and strobing circuits may be used to control illumination of LEDs in a bank. Theoretically, each individual LED in an LED bank may be individually controlled under its own clock pulse sequence. Thus, continuing with the above example, a 40 LED bank may be configured such that each LED has a unique sequence, resulting in 40 independent illumination sequences for each LED. Such a configuration is advantageous in that it provides a user of the disruption device a wide array of alternatives for creating an optimally disruptive illumination pattern for a given application.

Continuing with the example of FIG. 1A, LEDs 154, 158 receive voltage V as shown in FIG. 1A, preferably from power source 106. In this example, both LEDs 154, 158 are infrared (IR) LEDs, configured to illuminate in the 700 nm to 1.0 mm spectrum range. LED 154 is operatively coupled to transistor pair 152, 153, where the emitter of transistor 153 is coupled to resistor 155. In the case of bipolar transistors, the collector current is largely independent of the collector voltage. Thus, when the base of transistor 153 is raised to a particular voltage, the emitter will follow, placing a fixed voltage on resistor 155, which therefore causes a fixed voltage to flow through it. As most of the current will flow though the collector, resistor 155 acts as a kind of voltage controlled current sink. To provide additional current gain, transistor 152 is coupled to transistor 153 as a Darlington pair such that current amplified by transistor 152 is further amplified by transistor 153. Such a configuration provides a greater common/emitter current gain than each transistor taken separately, and, in the case of integrated devices, can take less space than two individual transistors because they can utilize a shared collector.

LED 158 is similarly arranged as LED 154 using transistors 156, 157 and resistor 159. As clock pulse 150 is applied for LED 154, the LED illuminates during each “high” pulse, and turns off during each “low” pulse. As clock pulse 151 comprises a different clock pulse sequence, LED 158 turns on and off at different times from LED 154. Thus, as an example, configuring LEDs 154 and 158 as a bank in a checkered pattern would result LEDs 154 turning on and off in one time sequence, while LEDs 158 (in alternating spaces in the “checker”) turning on and off in a different sequence. Of course, this is merely one example, and one skilled in the art would appreciate that multiple configurations are contemplated in the present disclosure. Furthermore, the exemplary strobing circuit of FIG. 1A is merely one illustrative example should not be construed as a limiting embodiment. Indeed, a wide multitude of different strobing circuits are contemplated in the present disclosure and may be readily substituted in the example of FIG. 1A by one skilled in the art, depending on the application used.

Furthermore, it should be appreciated by those skilled in the art that different types of LEDs may be used and controlled under the present disclosure. In one embodiment, one group of the LEDs may be IR LEDs configured to operate under a first spectrum (e.g., 850 nm or 860 nm), while a second group may be configured to operate under a second spectrum (e.g., 960 nm). By alternating the LEDs between one spectrum and another, a wider spectrum of defensive illumination may be advantageously enabled. By using three or more spectral groups of IR LEDs, an even wider scope of spectrum illumination may be achieved.

In another advantageous embodiment, IR LEDs may be combined with other LED types, such as high intensity white light LEDs, phosphor-based LEDs, and other suitable LED types for creating intense light for disrupting night vision. In this example, the multitude of different LEDs may be pulsed to provide a wide array of disruptive illumination.

Turning now to FIG. 2, an exemplary illustration of a disruptive device 200 is provided, where device 200 is configured as a light-emitting hand grenade. In this example, device 200 is configured to be carried by a user and thrown in the direction of suspected or detected night-vision devices in use. Device 200 includes a device body comprising a middle portion 201, a top portion 203 and a bottom portion 202 as shown in the example FIG. 2, where top portion 203 and bottom portion 202 preferably extend circumferentially over center portion 201 to advantageously form a gripping surface for device 200. Of course, the illustrated embodiment of FIG. 2 is merely one example and other device body shapes are contemplated including spherical, cylindrical, rectangular, triangular, or any suitable polygon shape that is capable of being grasped by a human hand, or alternately mounted on a stand. In a preferred embodiment, all of the primary circuitry discussed above in connection with FIGS. 1-1A are contained with the body of device 200, which may be ruggedized to provide impact and environmental resistance.

A trigger, comprising ring 206 and pin 205 is operatively coupled to a fastener portion 204, which is fastened to top portion 203. Ring 206 and pin 205 may collectively operate as a mechanical or electromechanical trigger (e.g., see FIG. 1, ref. 102), where pulling ring 206 causes pin 205 to extend and provide (switch on) an activation signal for the circuitry of device 200. In one embodiment, pin 205 is spring loaded, allowing it to resiliently retract back into the same position prior to pulling. A charging/recharging plug 211 may be provided in bottom portion 202 or other suitable area to provide charging power for batteries or other power-providing devices (106).

Middle portion 201 of device 200 also includes a lighting arrangement comprising a plurality of lights 207, 209 that are seated within reflectors 208, 210. In a preferred embodiment, the lights are positioned to cover the surface area of middle portion 201 circumferentially to provide a 360° area of illumination for the area. The lights may be arranged in circumferential rows as illustrated, or may be arranged in a circumferential checker pattern. Other light patterns are contemplated in the present disclosure as well. The lights may further be configured as omnidirectional or directional lights (or a combination thereof) to provide a wide array of defensive illumination.

The type of lights used in device 200 may vary as described above, where, for example, one row of lights (207) are of one light type (e.g., IR), while another row of lights (209) are of a second light type (e.g., high-intensity white light). Additional light types may further be added depending on the application and arranged in any suitable illumination pattern. Each light is also embedded in a light reflector (208, 210) which may be configured as a parabolic reflector or mirror, or an off-axis reflector or minor. While not explicitly shown in the example, the lighting arrangement may further include optical filters and/or diffusers to further customize the defensive illumination needed. Furthermore, reflection lenses may be used to provide still further options in the

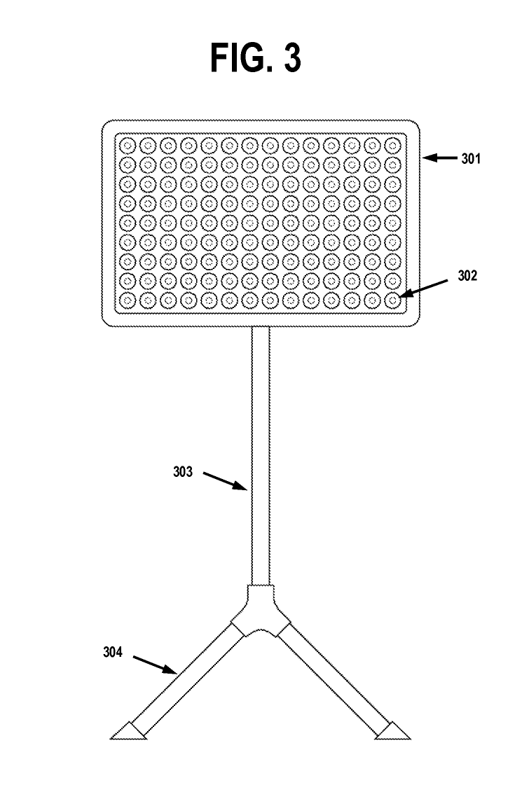

Turning now to FIG. 3, another embodiment is disclosed where lights 302 are mounted on a panel 301, which may be elevated by a stand 303 and stabilized via footings 304. The lighting configuration and circuitry in the example of FIG. 3 may be the same or similar to any of the embodiments described herein. The light array of FIG. 3 may be advantageous for defensive applications where one or more panels may be deployed to tactical areas, such as alleys, roads, windows, etc. As described above, panel 301 may also be triggered via sensors or remote communication.

It should be clear to those skilled in the art that the present disclosure is not limited to the specific embodiments described herein. For example, the panel of FIG. 3 may be reduced in size and configured with a securing mechanism to allow one or more panels to be secured to a person's head or helmet. Similarly, the panel may be fitted with a chain or other suitable necklace to be worn around the neck of an individual. The panels could also be configured to be secured to vehicles. In one advantageous embodiment, the LED lighting arrangement may be sewn into the fabric of clothing, where the article of clothing effectively operates as a disruptive light panel of the kinds discussed above.

The present disclosure illustrates multiple systems, apparatuses and methods for disrupting night vision, and particularly technologies utilizing IR. Various IR equipment is designed such that it relies upon IR signatures. The IR defense system disclosed herein advantageously provides disruption, confusion, disorientation and possible temporary blindness to uses of such equipment. Under optimal operation, the defense light makes IR equipment inoperable. The equipment concerned could be, but is not limited to, nightvision goggles, IR signature cameras, IR guided missile systems, night vision rifle scopes or heat signature satellites.

The IR defense light may be strobed or continuously on, so when looked at through a night vision capable device it floods the vision field such that the operator of the night vision device is rendered visually incapacitated. The device may be used in military, domestic and general defense situations where night vision is likely to be used, the device may be thrown (like a grenade), gun mounted or a fixed/mounted installation. The device may also be used in alternative applications such as defense of property from night vision use through IR flooding. IR may be emitted for either short durations for immediate defense or for longer durations to provide a continuous flood effect.

In another illustrative and exemplary embodiment, a method is disclosed for disrupting the night vision ability of an aircraft (such as helicopter or airplane) in an area surrounding the apparatus, wherein the method comprised the steps of detecting, via radar in or linked to the apparatus, a physical characteristic in or around the apparatus and providing the activation signal in the apparatus based on the detected physical characteristic. The method further comprises activating a control circuit in the apparatus from the activation signal to cause illumination of the IR light emitting diodes to disrupt the night vision capability of said aircraft.

In the foregoing Detailed Description, it can be seen that various features are grouped together in individual embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus for disrupting night vision ability in an area surrounding the apparatus, comprising:
a first trigger for generating a first activation signal for the apparatus;
a sensor configured to detect a physical characteristic in or around the apparatus;
a second trigger, operatively coupled to the sensor, wherein the second trigger provides a second activation signal based on the detected physical characteristic in the sensor;
a control circuit, operatively coupled to the first and second trigger, the control circuit comprising a strobing circuit; and
a plurality of light emitting diodes arranged in a predetermined pattern, wherein the control circuit is configured to cause illumination of each of the plurality of light emitting diodes in a predetermined pattern to disrupt night vision in the area.

2. The apparatus of claim 1, wherein the light emitting diodes comprise infra-red emitting diodes.

3. The apparatus of claim 1, wherein the light emitting diodes comprise infra-red emitting diodes and white light emitting diodes.

4. The apparatus of claim 3, wherein the control circuit is configured to illuminate the infra-red emitting diodes and white light emitting diodes in a predetermined sequence.

5. The apparatus of claim 1, wherein the sensor comprises an accelerometer, and wherein the second trigger provides the second activation signal based on the physical characteristic sensed by the accelerometer.

6. The apparatus of claim 1, further comprising communications operatively coupled to the control circuit, wherein the communications is configured to transmit and receive data wirelessly.

7. The apparatus of claim 6, wherein data comprises information regarding the detected physical characteristics in the sensor.

8. The apparatus of claim 7, wherein the communications is configured to receive instructions to produce the second activation signal.

9. A method for disrupting night vision ability in an area surrounding an apparatus, comprising the steps of:
detecting, via a sensor in the apparatus, a physical characteristic in or around the apparatus;
providing an activation signal in the apparatus based on the detected physical characteristic;
activating a control circuit in the apparatus from the activation signal to cause illumination of each of a plurality of light emitting diodes in a predetermined pattern to disrupt night vision in the area.

10. The method of claim 9, wherein the light emitting diodes comprise infra-red emitting diodes.

11. The method of claim 9, wherein the light emitting diodes comprise infra-red emitting diodes and white light emitting diodes.

12. The method of claim 11, wherein activating the control circuit comprises illuminating the infra-red emitting diodes and white light emitting diodes in a predetermined sequence.

13. The method of claim 9, wherein the sensor comprises an accelerometer, and wherein the activation signal is provided based on the physical characteristic sensed by the accelerometer.

14. The method of claim 9, further comprising communications operatively coupled to the control circuit, wherein the communications is configured to transmit and receive data wirelessly.

15. The method of claim 14, wherein data comprises information regarding the detected physical characteristics in the sensor.

16. The method of claim 15, wherein the communications is configured to receive instructions to produce the second activation signal.

17. An apparatus for disrupting night vision ability in an area surrounding the apparatus, comprising:
a trigger, configured to provide an activation signal based on a stimulus;
a control circuit, operatively coupled to the trigger, the control circuit comprising a strobing circuit; and
a plurality of light emitting diodes comprising a plurality of diode types arranged in a predetermined pattern, wherein the control circuit is configured to independently cause illumination of each diode type of the plurality of light emitting diodes in a predetermined pattern to disrupt night vision in the area.

18. The apparatus of claim 17, wherein the light emitting diodes comprise infra-red emitting diodes and white light emitting diodes.

19. The apparatus of claim 18, wherein the control circuit is configured to illuminate the infra-red emitting diodes and white light emitting diodes in a predetermined sequence.

20. The apparatus of claim 17, further comprising communications operatively coupled to the control circuit, wherein the communications is configured to transmit and receive data wirelessly, and wherein the data comprises the stimulus.

21. A method for disrupting night vision ability in an area surrounding an apparatus, comprising the steps of:
detecting and/or tracking, via radar, a physical characteristic in or around the apparatus;
providing an activation signal in the apparatus based on the detected physical characteristic;
activating a control circuit in the apparatus from the activation signal to cause illumination of each of a plurality of light emitting diodes in a predetermined pattern to disrupt night vision to the detected physical characteristic;
following and tracking the physical characteristic.

22. The method of claim 21, wherein the light emitting diodes comprise infra-red emitting diodes.

23. The method of claim 21, wherein the light emitting diodes maybe focused on to the tracked physical characteristic.

24. The method of claim 21, wherein the physical characteristic could be an aircraft such as airplane or helicopter.
